(19) United States
(12) Patent Application Publication
(10) Pub. No.: US 2016/0044545 A1
(43) Pub. Date: Feb. 11, 2016

(54) FAST RETURN AFTER CIRCUIT SWITCHED FALL BACK (CSFB) RADIO RESOURCE CONTROL CONNECTION FAILURE

(71) Applicant: QUALCOMM Incorporated, San Diego, CA (US)

(72) Inventors: Ming YANG, San Diego, CA (US); Tom CHIN, San Diego, CA (US); Roy Howard DAVIS, Del Mar, CA (US)

(21) Appl. No.: 14/451,794

(22) Filed: Aug. 5, 2014

(51) Int. Cl. H04W 36/00

(52) U.S. Cl. CPC H04W 36/0022

(57) ABSTRACT

A user equipment (UE) improves wireless communication when the UE returns or attempts to return to a first radio access technology (RAT) from a second RAT after a circuit switched fall back (CSFB) call failure due to a radio resource control (RRC) connection failure. In one instance, the UE successfully redirects to the second RAT from a first RAT. The UE then determines that the circuit switched fall back call on the second RAT failed. In response to the determination of the failure, the UE waits for a predetermined amount of time for second RAT re-paging or a user re-initiating the circuit switched call. The UE then performs fast return to the first RAT after the predetermined amount of time expires or in response to a user input.

### BACKGROUND

1. Field

Aspects of the present disclosure relate generally to wireless communication systems, and more particularly, to fast return from a second radio access technology (RAT) to a first RAT upon expiration of a predetermined time. The fast return occurs after redirection of a call with the second RAT fails.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division—code division multiple access (TD-CDMA), and time division—synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes successfully redirecting a user equipment (UE) to a second radio access technology (RAT) from a first RAT. The method also includes determining a circuit switched call on the second RAT has failed. The method also includes waiting a predetermined amount of time for second RAT re-paging or a user re-initiating the circuit switched call, after the circuit switched call is determined to have failed. The method further includes performing fast return to the first RAT after the predetermined amount of time expires or in response to a user input.

According to another aspect of the present disclosure, an apparatus for wireless communication includes means for successfully redirecting a user equipment (UE) to a second radio access technology (RAT) from a first RAT. The apparatus may also include means for determining a circuit switched call on the second RAT has failed. The apparatus may also include means for waiting a predetermined amount of time for second RAT re-paging or a user re-initiating the circuit switched call, after the circuit switched call is determined to have failed. The apparatus may further include means for performing fast return to the first RAT after the predetermined amount of time expires or in response to a user input.

Another aspect discloses a computer program product for wireless communications in a wireless network having a non-transitory computer-readable medium. The computer readable medium has non-transitory program code recorded thereon which, when executed by the processor(s), causes the processor(s) to perform the operation of successfully redirecting a user equipment (UE) to a second radio access technology (RAT) from a first RAT. The program code also causes the processor(s) to determine a circuit switched call on the second RAT has failed. The program code also causes the processor(s) to wait a predetermined amount of time for second RAT re-paging or a user re-initiating the circuit switched call, after the circuit switched call is determined to have failed. The program code also causes the processor(s) to perform fast return to the first RAT after the predetermined amount of time expires or in response to a user input.

Another aspect discloses an apparatus for wireless communication and includes a memory and at least one processor coupled to the memory. The processor(s) is configured to successfully redirect a user equipment (UE) to a second radio access technology (RAT) from a first RAT. The processor(s) is also configured to determine a circuit switched call on the second RAT has failed. The processor(s) is also configured to wait a predetermined amount of time for second RAT re-paging or a user re-initiating the circuit switched call, after the circuit switched call is determined to have failed. The processor(s) is further configured to perform fast return to the first RAT after the predetermined amount of time expires or in response to a user input.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5A is a call flow diagram illustrating a redirection procedure according to aspects of the present disclosure.

FIG. 5B is a call flow diagram illustrating a redirection procedure according to aspects of the present disclosure.

FIG. 6 is a flow diagram illustrating a method for wireless communication according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

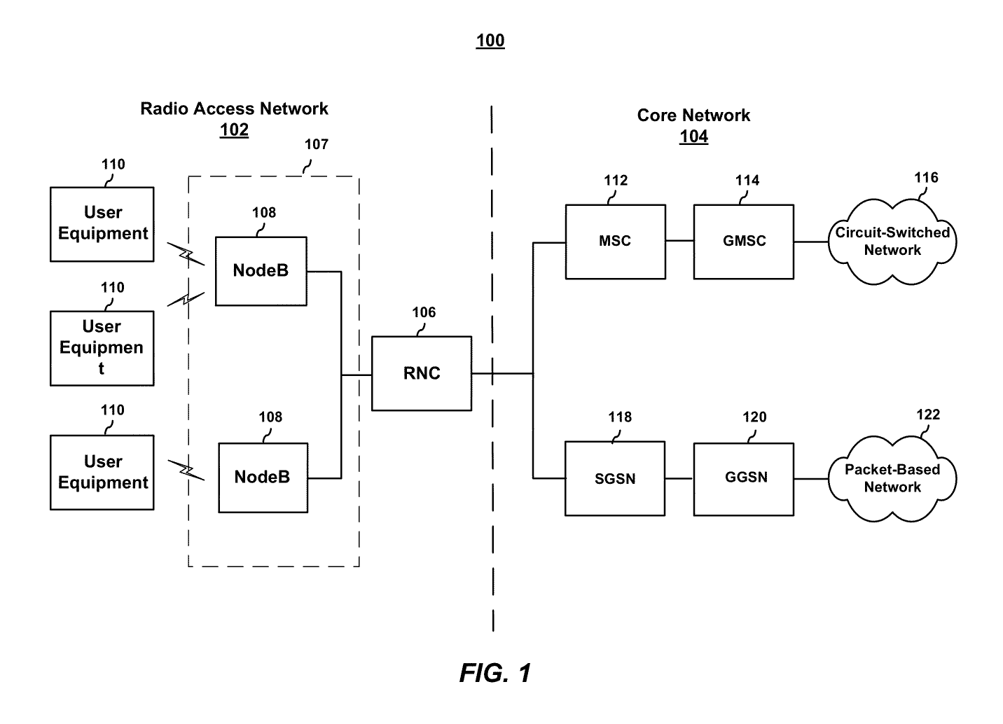

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

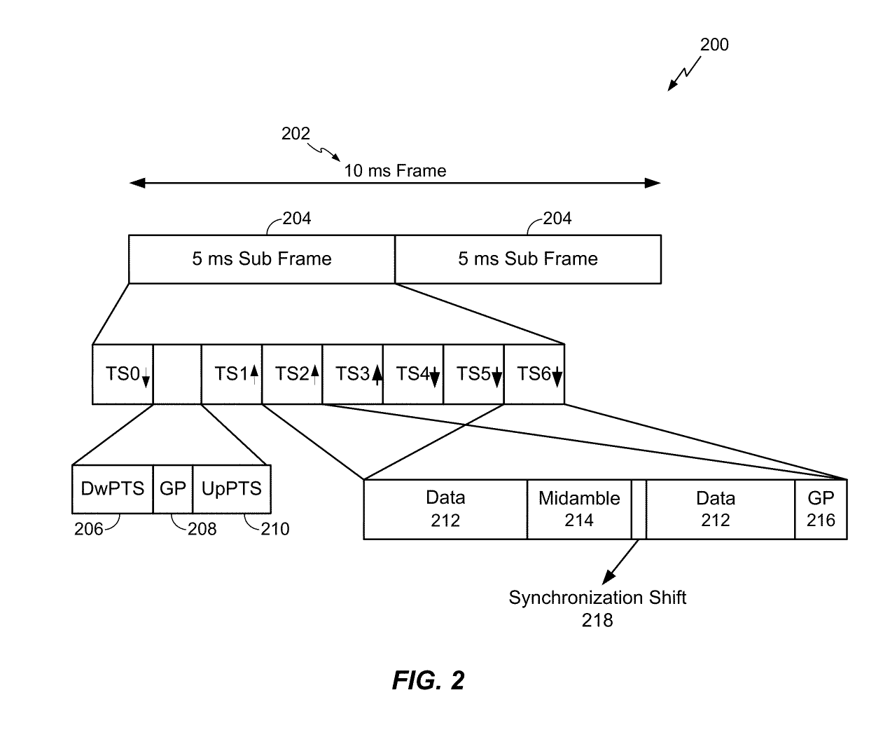

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

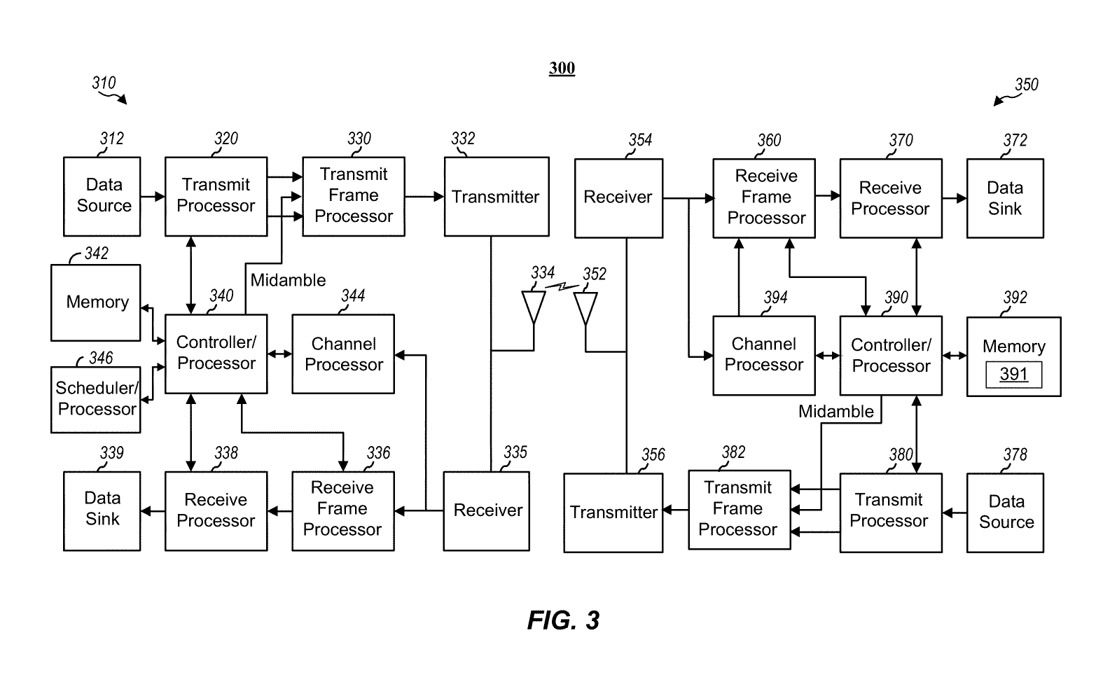

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a circuit switched fall back (CSFB) call establishment module 391, which when executed by the controller/processor 390, configures the UE 350 to return from a second radio access technology (RAT) to a first RAT upon expiration of a predetermined time, after redirection of a circuit switched call to the second RAT fails. A scheduler/processor 346 at the node B 310 may be used to allocate resources to the UEs and schedule downlink and/or uplink transmissions for the UEs.

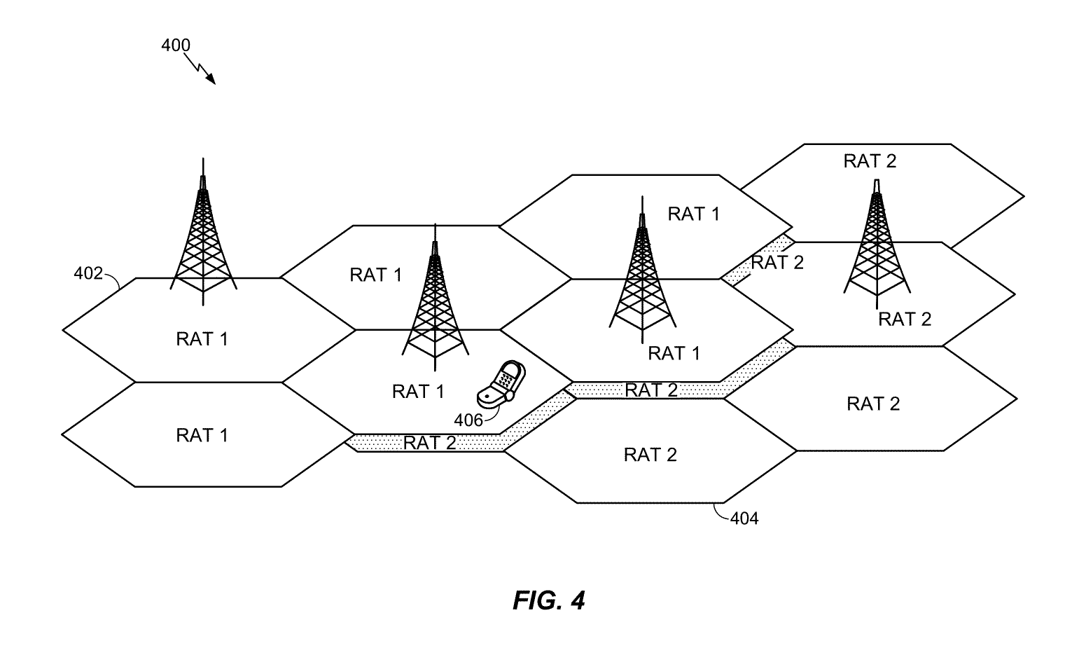

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA and also illustrates a newly deployed network utilizing a second type of radio access technology (RAT-2), such as long term evolution (LTE).

The geographical area 400 may include RAT-1 cells 402 and RAT-2 cells 404. In one example, the RAT-1 cells 402 are TD-SCDMA/GSM cells and the RAT-2 cells 404 are LTE cells. However, those skilled in the art will appreciate that other types of radio access technologies may be utilized within the cells. A user equipment (UE) 406 may move from one cell, such as a RAT-1 cell 402, to another cell, such as a RAT-2 cell 404. The movement of the UE 406 may specify a handover or a cell reselection.

Redirection from one RAT to another RAT is commonly used to perform operations such as load balancing or circuit switched fallback from one RAT to another RAT. For example, one of the RATs may be long term evolution (LTE) while the other RAT may be universal mobile telecommunications system—frequency division duplexing (UMTS FDD), universal mobile telecommunications system—time division duplexing (UMTS TDD), or global system for mobile communications (GSM). In some aspects, the redirection may be from a frequency or cell of one RAT to a frequency or cell of the same RAT.

Circuit switched fall back is a feature that enables multimode user equipments (UEs) that are capable of communicating on a first RAT (e.g., LTE) in addition to communicating on a second RAT (e.g., second/third generation (2G/3G) RAT) to obtain circuit switched voice services while being camped on the first RAT. For example, the circuit switched fall back capable UE may initiate a mobile-originated (MO) circuit switched voice call while on LTE. Because of the mobile-originated circuit switched voice call, the UE is redirected to a circuit switched capable RAT. For example, the UE is redirected to a radio access network (RAN), such as a 3G/2G network, for the circuit switched voice call setup. In some instances, the circuit switched fall back capable UE may be paged for a mobile-terminated (MT) voice call while on LTE, which results in the UE being moved to 3G or 2G for the circuit switched voice call setup.

FAST RETURN AFTER CIRCUIT SWITCHED FALL BACK (CSFB) RADIO RESOURCE CONTROL CONNECTION FAILURE

Aspects of the present disclosure are directed to improving wireless communication when a user equipment (UE) returns or attempts to return to a first radio access technology (RAT) from a second RAT after a circuit switched fall back (CSFB) call failure. In some aspects of the disclosure, the UE may be successfully redirected from the first RAT (e.g., packet switched (PS) RAT) to the second RAT (circuit switched RAT) to establish a circuit switched call with the second RAT. The first RAT may be a long term evolution (LTE) RAT and the second RAT may be a second/third generation (2G/3G) RAT (e.g., global system for mobile (GSM) or time division synchronous code division multiple access (TD-SCDMA)). The UE may determine that the circuit switched call on the second RAT failed due to the RRC connection failure. For example, the circuit switched call failure may occur when the UE fails to set up the circuit switched voice call or drops the voice call after call set up. To mitigate effects of the failure, the UE waits a predetermined amount of time on the second RAT so that the UE can receive pages (or be re-paged) on the second RAT or re-initiate a circuit switched call on the second RAT before attempting to return to the first RAT. For example, the UE returns to or attempts to return to the first RAT after the predetermined amount of time expires before the circuit switched call is established or in response to a user input.

In some instances, when the UE is redirected to the second RAT (e.g., circuit switched RAT) the UE fails to set up the circuit switched voice call or drops the voice call after call set up. For example, the circuit switched call failure may be due to a radio resource control (RRC) connection failure. Failure to set up the radio resource control connection may correspond to broadcast control channel (BCCH) decoding failure, random access procedure failure, or radio resource setup procedure or connection establishment failure. When the call setup failure occurs or the UE drops the voice call, the UE may not receive a connection release message from the second RAT. As a result, the UE may enter idle mode in the second RAT.

In idle mode, the UE may stay on the second RAT to attempt to establish the circuit switched voice call or fast return to the first RAT. When the UE returns to the first RAT after the failure or dropped call, the UE may receive the page at the first RAT again causing the UE to be redirected back to the first RAT. Multiple redirections to the second RAT and multiple returns to the first RAT to establish the voice call degrades the user experience and is therefore undesirable.

When the UE stays on the second RAT during idle mode, the UE may receive a page (i.e., mobile terminated) or initiate a voice call (i.e., mobile oriented) directly to the second RAT to set up the voice call without the circuit switched fall back procedure. However, when the voice call is subject to failure, the UE may continue to attempt to initiate or receive the voice call for an undefined period of time. As a result, the UE stays at the second RAT for a longer time causing a delayed return to the first RAT.

Aspects of the present disclosure are directed to expediting the return of the UE to the first RAT or improving voice call setup when the UE is redirected to the second RAT but fails to set up the voice call or drops a successfully established voice call.

In some aspects of the disclosure, the UE prioritizes the circuit switched call when the UE fails to set up the circuit switched voice call or drops the voice call after call setup. In this case, the UE stays on the second RAT for a predetermined amount of time to establish or re-establish the voice call at the second RAT. For example, the UE waits for the predetermined amount of time for a mobile terminated page or user initiated call to be setup at the second RAT.

When the UE fails to establish or re-establish the voice call at the second RAT within the predetermined amount of time, the UE switches priority to the first RAT. For example, the UE switches priority to LTE for a packet switched call. In the first RAT priority state, the UE no longer attempts to establish the circuit switched call. Rather, the UE attempts to return to the first RAT. For example, the UE may attempt to return to the first RAT by performing a blind fast return. To perform blind fast return to the first RAT, the UE selects a target first RAT cell or frequency based on history. For example, the target first RAT cell or frequency may be based on previous first RAT acquisition history or a public land mobile network (PLMN). When the UE establishes the circuit switched call with the circuit switched RAT within the predetermined amount of time, the UE may return or attempt to return to the first RAT after the second RAT releases the circuit switched call.

In some aspects of the disclosure, the UE switches priority back to the first RAT based on an action or input from a user. For example, the UE switches priority to the first RAT when a user presses an end call button. The user may press the end call button in response to the circuit switched call setup failure or dropped call. Pressing the end call button indicates that the user has either rejected an incoming call or changed their mind about originating a call. Either way, the UE switches priority to the first RAT and attempts to return to the first RAT.

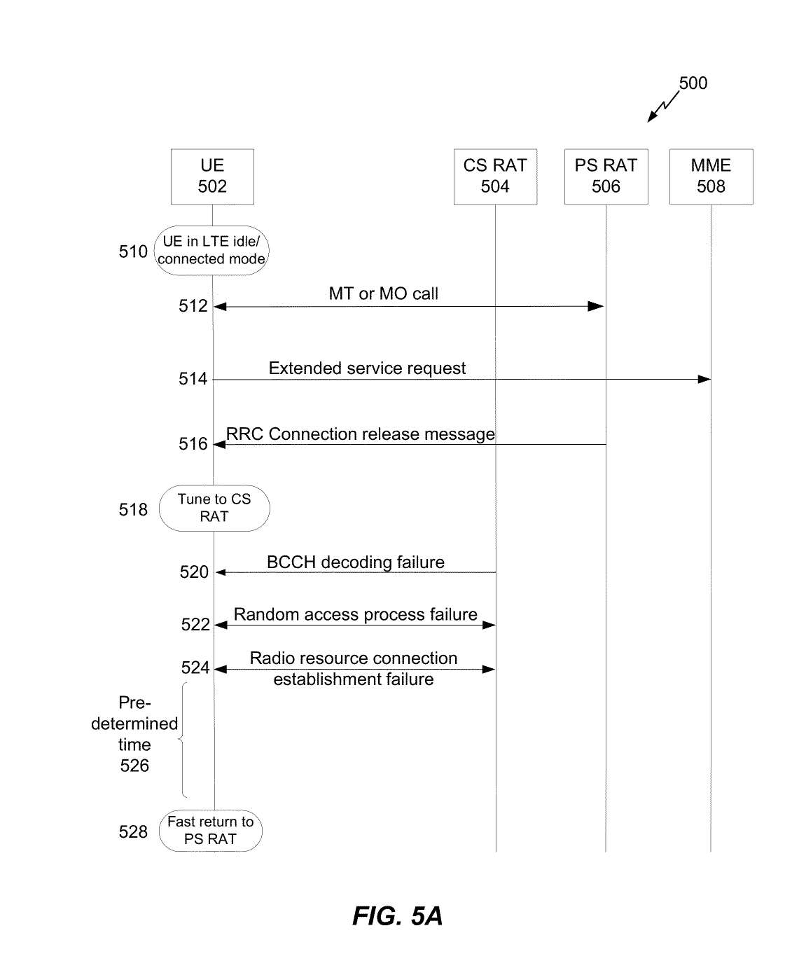

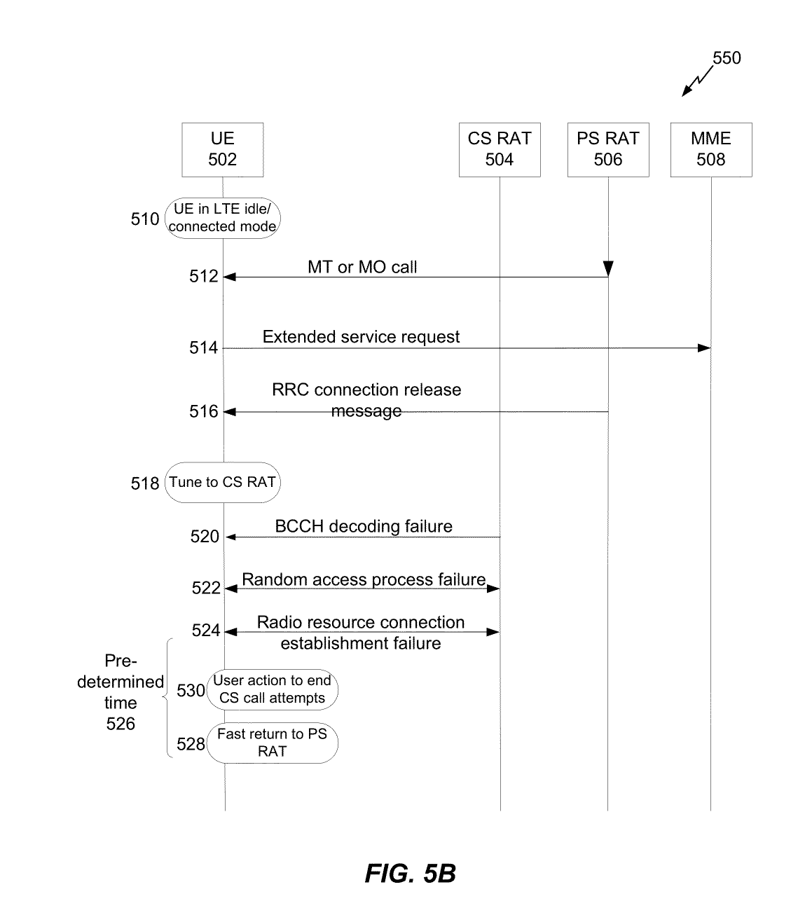

FIG. 5A is a call flow diagram 500 illustrating a redirection procedure according to aspects of the present disclosure. At time 510, a circuit switched fall back UE 502 is in idle mode or connected mode with a packet switched (PS) RAT 506 (e.g., LTE). While in the idle or connected mode, the UE 502 may be paged for a mobile-terminated (MT) voice call or may initiate a mobile-originated (MO) voice call, at time 512. In response to the mobile terminated or mobile oriented call, the UE 502 communicates with a mobility management entity (MME) 508 via the packet switched RAT 506. For example, at time 514, the UE 502 transmits an extended service request to the MME 508. The extended service request may be an indicator for the mobile-originated or mobile-terminated circuit switched fallback call.

To establish the mobile terminated or mobile oriented voice call, the UE 502 is redirected to a circuit switched RAT 504 for the circuit switched voice call setup. For example, at time 516, the packet switched RAT 506 transmits a connection release message to the UE 502, such as a radio resource control (RRC) connection release message. The radio resource control connection release message may include redirection information for the circuit switched RAT 504. At time 518, the UE 502 tunes to the frequency of the circuit switched RAT 504.

In some instances, when the UE 502 is redirected to a circuit switched RAT 504, the UE 502 fails to set up the circuit switched voice call or drops the voice call after call setup. The failure to setup the voice call or the resulting dropped call may be due to an RRC connection failure. In some aspects, the failure may correspond to broadcast control channel (BCCH) decoding failure, at time 520, random access process failure, at time 522, and/or radio resource connection establishment or setup failure, at time 524. When the call setup failure occurs or the UE drops the voice call, the UE 502 does not receive a connection release message from the second RAT resulting in the user experience being degraded.

To mitigate the degraded user experience, the UE 502 prioritizes the circuit switched call when the UE 502 fails to set up the circuit switched voice call or drops the voice call after call set up. In this case, the UE 502 stays on the circuit switched RAT 504 for a predetermined amount of time 526 to attempt to establish or re-establish the circuit switched voice call at the circuit switched RAT 504. For example, the UE 502 waits for a network generated mobile terminated page for the predetermined amount of time or waits for a user initiated mobile originated call setup for the predetermined amount of time 526.

When the UE 502 fails to establish or re-establish the voice call at the circuit switched RAT 504 within the predetermined amount of time 526, the UE 502 switches priority to the packet switched RAT 506. For example, the UE 502 switches priority to the packet switched RAT 506 and performs blind fast return to LTE, at time 528. Otherwise, the UE 502 establishes the call with the circuit switched RAT 504 during the predetermined amount of time 526 and then returns to the packet switched RAT 506 (e.g., LTE network) after the call is released from the circuit switched RAT 504.

FIG. 5B is another call flow diagram 550 illustrating a redirection procedure according to aspects of the present disclosure. The flow of FIG. 5B is similar to the flow diagram of FIG. 5A. In FIG. 5B, however, the UE 502 switches priority back to the packet switched RAT 506 based on an action from a user (e.g., the user presses an end call button) rather than after the expiration of the predetermined amount of time 526, as in FIG. 5A.

For example, the user action in FIG. 5B occurs during the predetermined amount of time 526, at time 530. Thus, at time 530, the UE 502 switches priority to the packet switched RAT 506 when a user presses the end call button. Switching the priority to the packet switched RAT 506 causes the UE 502 to attempt to return back to the packet switched RAT 506 of the LTE network. For example, the UE 502 performs blind fast return to LTE, at time 528, in response to the user action at time 530. In some aspects, the user action at time 530 is performed independent of the predetermined amount of time 526.

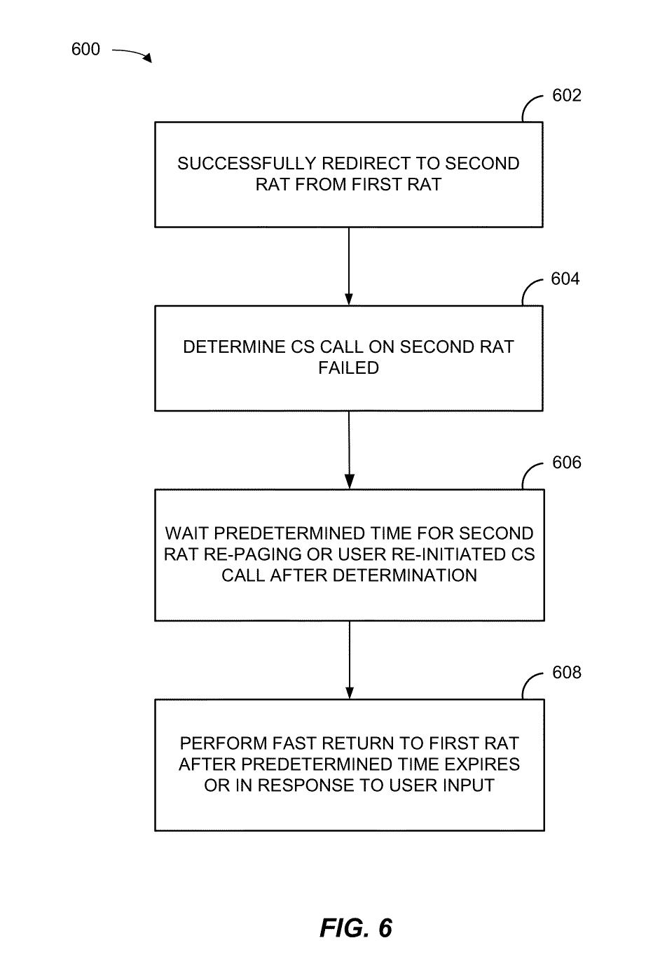

FIG. 6 shows a wireless communication method 600 according to one aspect of the disclosure. A UE successfully redirects to a second radio access technology (RAT) from a first RAT, as shown in block 602. The UE also determines a circuit switched call on the second RAT has failed, as shown in block 604. In response to the determination of failure, the UE waits a predetermined amount of time for second RAT re-paging or a user re-initiating the circuit switched call, as shown in block 606. The UE then performs fast return to the first RAT after the predetermined amount of time expires or in response to a user input, as shown in block 608.

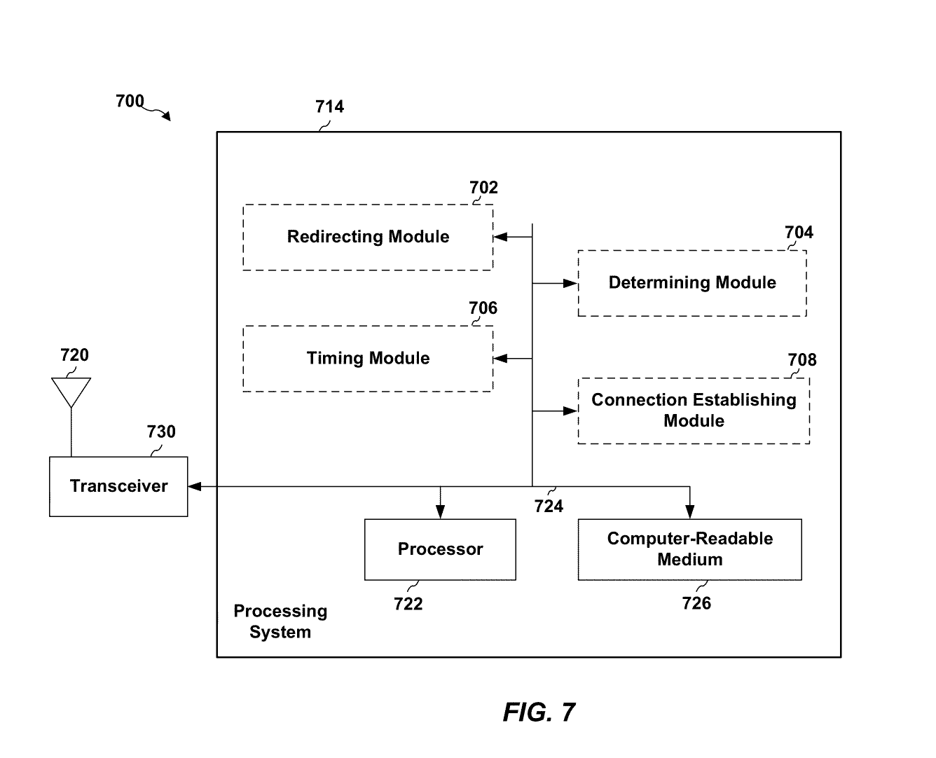

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706, 708 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a redirecting module 702 for successfully redirecting to a second radio access technology (RAT) from a first RAT. The processing system 714 includes a determining module 704 for determining a circuit-switched circuit switched call on the second RAT has failed. The processing system 714 includes a timing module 706 for waiting a predetermined amount of time for second RAT re-paging or a user re-initiating the circuit switched call, after the circuit switched call is determined to have failed. The processing system 714 includes a connection establishing module 708 for performing fast return to the first RAT after the predetermined amount of time expires or in response to a user input. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for redirecting. In one aspect, the redirecting means may be the antennas 352/720, the receiver 354, the transceiver 730, the channel processor 394, the receive frame processor 360, the receive processor 370, the transmitter 356, the transmit frame processor 382, the transmit processor 380, the controller/processor 390, the memory 392, the CSFB call establishment module 391, the redirecting module 702 and/or the processing system 714 configured to perform the redirecting means. The UE is also configured to include means for determining. In one aspect, the determining means may be the controller/processor 390, the memory 392, the CSFB call establishment module 391, the determining module 704 and/or the processing system 714 configured to perform the aforementioned means.

The UE is also configured to include means for waiting. In one aspect, the waiting means may be the antennas 352/720, the receiver 354, the channel processor 394, the receive processor 370, the transmitter 356, the transmit processor 380, the controller/processor 390/722, the memory 392, the CSFB call establishment module 391, the timing module 706, the transceiver 730 and/or the processing system 714 configured to perform the waiting means. The UE is also configured to include means for performing fast return to the first RAT. In one aspect, the fast return performing means may be the antennas 352/720, the receiver 354, the channel processor 394, the receive frame processor 360, the receive processor 370, the transmitter 356, the transmit frame processor 382, the transmit processor 380, the controller/processor 390, the memory 392, the CSFB call establishment module 391, the connection establishing module 708 and/or the processing system 714 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE and GSM/TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
successfully redirecting a user equipment (UE) to a second radio access technology (RAT) from a first RAT;
determining a circuit switched call on a second RAT has failed;
waiting a predetermined amount of time for second RAT re-paging or a user re-initiating the circuit switched call, after the circuit switched call is determined to have failed; and
performing fast return to the first RAT after the predetermined amount of time expires or in response to a user input.

2. The method of claim 1, in which the first RAT comprises a packet switched RAT and the second RAT comprises a circuit switched RAT.

3. The method of claim 1, in which the circuit switched call on the second RAT failed when call setup failed or when the circuit switched call was dropped.

4. The method of claim 1, further comprising prioritizing the first RAT after the predetermined amount of time expires or in response to the user input.

5. The method of claim 1, further comprising prioritizing the second RAT, after determining failure, for the predetermined amount of time.

6. An apparatus for wireless communication, comprising:
means for successfully redirecting a user equipment (UE) to a second radio access technology (RAT) from a first RAT;
means for determining a circuit switched call on a second RAT has failed;
means for waiting a predetermined amount of time for second RAT re-paging or a user re-initiating the circuit switched call, after the circuit switched call is determined to have failed; and
means for performing fast return to the first RAT after the predetermined amount of time expires or in response to a user input.

7. The apparatus of claim 6, in which the first RAT comprises a packet switched RAT and the second RAT comprises a circuit switched RAT.

8. The apparatus of claim 6, in which the circuit switched call on the second RAT failed when call setup failed or when the circuit switched call was dropped.

9. The apparatus of claim 6, further comprising means for prioritizing the first RAT after the predetermined amount of time expires or in response to the user input.

10. The apparatus of claim 6, further comprising means for prioritizing the second RAT, after determining failure, for the predetermined amount of time.

11. An apparatus for wireless communication, comprising:
a memory; and
at least one processor coupled to the memory and configured:
to successfully redirect a user equipment (UE) to a second radio access technology (RAT) from a first RAT;
to determine a circuit switched call on a second RAT has failed;
to wait a predetermined amount of time for second RAT re-paging or a user re-initiating the circuit switched call, after the circuit switched call is determined to have failed; and
to perform fast return to the first RAT after the predetermined amount of time expires or in response to a user input.

12. The apparatus of claim 11, in which the first RAT comprises a packet switched RAT and the second RAT comprises a circuit switched RAT.

13. The apparatus of claim 11, in which the circuit switched call on the second RAT failed when call setup failed or when the circuit switched call was dropped.

14. The apparatus of claim 11, in which the at least one processor is further configured to prioritize the first RAT after the predetermined amount of time expires or in response to the user input.

15. The apparatus of claim 11, in which the at least one processor is further configured to prioritize the second RAT, after determining failure, for the predetermined amount of time.

16. A computer program product for wireless communication, comprising: a non-transitory computer-readable medium having program code recorded thereon, the program code comprising:
program code to successfully redirect a user equipment (UE) to a second radio access technology (RAT) from a first RAT;
program code to determine a circuit switched call on a second RAT has failed;
program code to wait a predetermined amount of time for second RAT re-paging or a user re-initiating the circuit switched call, after the circuit switched call is determined to have failed; and
program code to perform fast return to the first RAT after the predetermined amount of time expires or in response to a user input.

17. The computer program product of claim 16, in which the first RAT comprises a packet switched RAT and the second RAT comprises a circuit switched RAT.

18. The computer program product of claim 16, in which the circuit switched call on the second RAT failed when call setup failed or when the circuit switched call was dropped.

19. The computer program product of claim 16, further comprising program code to prioritize the first RAT after the predetermined amount of time expires or in response to the user input.

20. The computer program product of claim 16, further comprising program code to prioritize the second RAT, after determining failure, for the predetermined amount of time.
